(19) United States
(12) Patent Application Publication
(10) Pub. No.: US 2006/0271439 A1
(43) Pub. Date: Nov. 30, 2006

(54) Synthetic warehouse club

(76) Inventor: Kenneth R. Goldberg, Sharon, MA (US)

Correspondence Address: Mark S. Leonardo, Esq.;Brown Rudnick Berlack Israels LLP, One Financial Center, Boston, MA, 02111, US

(21) Appl. No.: 11/442,854

(22) Filed: May 30, 2006

Related U.S. Application Data
(60) Provisional application No. 60/685,257, filed on May 27, 2005.

(51) Int. Cl. G06Q 30/00

(52) U.S. Cl. 705/14

(57) ABSTRACT

A system providing members with cash rewards and other promotional benefits for purchases that they make from vendors participating in a network. Additional benefits may be furnished by manufacturers and/or distributors on the purchase of specific products, services, or brands. The amount of member benefits with respect to any period may be subject to a network-wide and/or vendor-specific cap. The members' cash rewards and other promotional benefits are charged to the participating vendors. These vendor charges are allocated among the vendors in proportion to their respective shares of network-wide sales to members. Members pay membership fees to the central system. All or part of the membership fees are paid over to the participating vendors, or are credited against their vendor charges.

### CROSS REFERENCE TO RELATED APPLICATIONS

This application claims priority to U.S. Provisional Patent Application Ser. No. 60/685,257 filed in the U.S. Patent and Trademark Office on May 27, 2005 which is incorporated herein by reference in its entirety.

### BACKGROUND

1. Technical Field

This invention generally relates to methods of conducting business, and more specifically to a method of conducting business through an integrated communications system and network of participants that provides rewards to network members who make purchases from sellers that participate in the network, and provides cash (or a reduction in costs) to the participating sellers.

2. Description of the Related Art

Traditional retailers often are hampered in their ability to compete effectively with wholesale or warehouse clubs (e.g., Costco, Sam's Club, BJ's). Warehouse clubs enjoy certain competitive advantages that generally are not available to traditional retailers. These advantages enable warehouse clubs to offer very low prices. In addition to attracting new customers, this encourages existing customers to shift more of their purchasing from traditional retailers to warehouse clubs. A warehouse club is able to maintain low prices by (a) generating high sales volumes, (b) charging membership fees, and (c) stocking an inventory of goods covering a wide array of product categories (though a relatively low number of stock-keeping units, or SKUs). Warehouse clubs, for example, carry such diverse products as clothing, health and beauty aids, fresh flowers, produce, groceries, baked goods, meats, furniture, tires, hardware, office supplies, books, computers, appliances, electronics, jewelry, and hardware.

The high sales volumes provide better coverage of fixed costs or overhead. This enables a warehouse club to reduce its gross margin to approximately 10%-13%, which is substantially lower than the 23%-30% gross margins typically maintained by traditional retailers. The lower prices drive sales volume. The resulting economies of scale allow fixed costs and overhead to be spread over greater amounts of revenue.

Membership fees provide warehouse clubs with an important source of capital. Although the fee is “earned” over the ensuing twelve-month period, the warehouse club collects the fee up-front. This provides the warehouse club with an important source of cost-free float or capital. The membership fee also contributes to higher sales volume by strengthening the customer's bond and loyalty to the warehouse club.

A warehouse club ensures that its members have the opportunity to shift greater amounts of their shopping to the club by carrying goods across a diverse range of product categories. Because membership benefits are tied to the total gross purchases made, a member can better justify paying an up-front membership fee if the warehouse club can satisfy a wide range of the member's overall product needs.

Rather than maintaining a year-round inventory of all product categories, warehouse clubs typically rotate certain product categories throughout the year with the ebb and flow of seasonal demand. At any given time, therefore, a warehouse club carries products that will generate high sales volumes at that time, while avoiding those that will yield only slight activity. For example, garden products are sold in late winter and early spring, camping items in late spring and early summer, back-to-school items in late summer, and holiday items in late fall. By rotating among product categories as the calendar changes, the warehouse club can meet each predictable and periodic surge of demand. Carrying certain items only during periods of peak demand allows the warehouse club to maximize its revenue. A specialty retailer cannot readily shift its merchandise mix with shifts in seasonal demand because it is expected always to maintain an inventory of items within its focused market category.

A warehouse club's ability to make frequent changes in its merchandise mix is facilitated by the nature of operating in a warehouse environment: using drop-shipment distribution systems, storing back-up items in overhead racks in the regular retail space, and displaying and selling items directly from the pallet. By contrast, traditional retailers are hampered in their ability to similarly shift their merchandise mix periodically throughout the year. Traditional retailers' distribution systems present logistical problems not faced by the drop-shipment distribution methods employed by warehouse clubs.

Warehouse clubs often reward members with cash or other benefits based on their levels of purchasing activity. These rewards or benefits provide a further incentive for members to maximize their spending at the warehouse club. The higher sales volume and better overhead-coverage efficiency often are further improved by a warehouse club's requiring members to pay a higher membership fee in order to avail themselves of the cash-back rewards or other benefits. The result is higher membership fee income to the warehouse club and an additional incentive for members to shift more of their shopping to the warehouse club. All of these factors work together to create, for warehouse clubs, a virtuous circle of lower gross margins and greater sales volumes.

Warehouse clubs, therefore, have enjoyed success at the expense of more traditional retailers. Some retailers have tried to compete by lowering prices. But without the advantages of the warehouse club model, these efforts generally prove unsustainable. A traditional grocer, pharmacy, hardware store, tire shop, office supplies retailer, clothing store, or electronics retailer, for example, cannot drive the same kind of volumes as a store capable of stretching its inventory mix across very diverse product categories. Traditional retailers lack the ability to offer the breadth of product categories of a warehouse club. Traditional retailers typically focus on their core markets. Accordingly, a traditional retailer must maintain throughout the entire year an inventory of virtually all its product categories. In addition, a traditional retailer lacks both the space of warehouse clubs and their flexibility in shifting the merchandise mix. Traditional retailers, therefore, cannot match a warehouse club's efficiency in periodically changing product categories with the changes in seasonal demand.

With a much narrower merchandise mix, traditional retailers cannot expect their customers to pay up-front membership fees. Because customers typically have broad product needs, they generally cannot justify paying a membership fee to each specialty retailer. Even if a customer could justify paying a small fee to each of several different specialty retailers, the cash rewards and other promotional benefits would have to be commensurately small or limited. Moreover, requiring a customer to maintain separate memberships with multiple retailers would inconvenience him or her, and would be a burden for the customer to administer and coordinate. The system that is the subject of the present disclosure addresses a key need of traditional retailers and the persons who rely on them. The system is designed to enable traditional retailers to compete effectively in the current and future retail environment. By participating in the system, a traditional retailer can provide members with promotional benefits and/or cash rewards. A combination of lower prices, up-front membership fees, and a broad array of product categories carried by the aggregate of retailers participating in the network together can drive sales volumes higher and offset any negative impact of reduced gross margins. In addition, the membership fees provide the retailers with cost-free float and more efficient coverage of their fixed charges and overhead expenses. This efficiency and capital provide traditional retailers with important resources that they sorely lack today.

By providing improved efficiency and incremental capital, the system enables the participating retailers to offer sustained low prices and/or cash rewards, which allows them to realize their competitive strengths: offering a greater selection of products (i.e., more SKUs), maintaining full product categories throughout the year, providing higher levels of service, and offering more convenient locations. Absent the system, these advantages alone are not sufficient to overcome the pricing power advantages of warehouse clubs. The system enables traditional retailers to provide members with aggressive pricing and other benefits. This narrows the gap between participating retailers and warehouse clubs, thereby enabling the participating retailers to more fully realize their competitive advantages.

The system, therefore, is designed to benefit participating retailers. Ultimately, a more competitive retail pricing environment also will benefit consumers generally. The system will benefit consumers by providing them with lower prices, cash rewards, and a better opportunity to realize the convenience, selection, and service offered by specialty retailers.

As is known, many promotional programs provide consumers with benefits that reward them for certain purchasing behavior. These programs are designed to induce consumers to increase those purchasing activities that are consistent with the marketing objectives. By tying a consumer's benefits to certain targeted purchases, these promotional programs provide consumers with an incentive to make such purchases.

Such promotional programs are deficient in that they do not provide a direct benefit to the retailers. The retailers may realize incremental sales, but the costs associated with the promotional programs can fully offset or even exceed the benefits of higher sales revenue. In addition, because customers typically may participate in the programs at no cost, the programs are less likely to generate consumer loyalty and extensive use. A traditional retailer cannot feasibly charge customers a fee to participate in these promotional programs for the reasons discussed above. The system that is the subject of the present disclosure addresses these deficiencies by requiring that members pay a fee in order to participate in the system, and by paying all or part of such membership fees to the participating retailers.

As is further known, certain warehouse clubs offer cash-back rewards to customers who pay a fee. Although the fee provides a direct benefit to the warehouse club and engenders customer loyalty, such programs are deficient because their feasibility is limited to only those retailers that carry items covering a broad enough cross-section of product categories to maximize a customer's spending opportunities. The system that is the subject of the present disclosure addresses this deficiency by allowing those retailers that offer a narrower selection of product categories to participate in a fee-based cash-reward marketing program. Absent the presently disclosed system, these more specialized retailers, as a practical matter, would lack the ability to compete directly with the warehouse clubs that offer similar programs.

Also known is a centralized cash value accumulation system for multiple merchants. McCarthy, RE36,116 (Feb. 23, 1999). That system centrally administers the separate cash-back rewards programs that are operated by a plurality of merchants. That system is deficient in that it does not provide for the payment of fees by consumers, and does not provide for the payment of membership fees to the merchants. Another important deficiency in that system is the lack of coordination among the various cash-back rewards programs of the merchants. In addition, that system is deficient in not providing consumers with any consistency or predictability in the benefits available at the various merchants.

The system that is the subject of the present disclosure addresses these deficiencies by providing for membership fees, and paying on to the participating retailers all or part of such fees. These payments can be an important source of capital to the retailers or can offset the costs they otherwise would bear with respect to the marketing and promotional program. By providing a mechanism for equitably allocating such costs and the membership fees among retailers, this system facilitates each retailer's participation in a fee-based cash-rewards program. A fee-based cash-reward program is not, as a practical matter, feasible for a retailer whose product offerings are not sufficiently broad. The presently disclosed system allows even specialty retailers to participate in such a program and to compete more effectively against warehouse clubs.

Another advantage of the system that is the subject of the present disclosure is its coordination of participating retailers. This coordination optimizes the cash-back program's efficiency to members: it enables members to minimize their cost of participating in such programs, and to maximize their member benefits with respect to purchases from the retailers in the aggregate. The presently disclosed system's flexibility allows a member to realize member benefits at a participating retailer even if such member's level of purchases there would not be high enough to justify paying a separate fee to such retailer.

The system that is the subject of the present disclosure also addresses the deficiency of lack of uniformity and consistency among all participating merchants. Allowing each merchant separately to set its own reward policies may not provide consumers with adequate predictability, and could burden consumers with undue complexity. By contrast, the system that is the subject of the present disclosure generally requires all participating retailers to adhere to the same levels of cash-back rewards. This facilitates each member's understanding and use of the system. As a result, this system offers greater appeal to members.

### SUMMARY

The present invention is a system that addresses problems faced by traditional retailers in competing against warehouse clubs. Customers become entitled to participate in the system by paying a membership fee. Part or all of the membership fees are allocated among the retailers, which produces an important source of capital. The system provides members with a cash-back reward for purchases they make from those retailers participating in the network. The system charges the retailers their allocable share of the cash-back rewards.

Members could receive, either in place of or in addition to cash-back rewards, price discounts on their purchases from some or all of the participating retailers. Additional benefits may be furnished by certain manufacturers and/or distributors on the purchase of certain specified products, services, or brands. Moreover, a membership card (or other device or means for identifying a member) could entitle the member to whatever benefits generally are available to customers holding a loyalty card issued by or for any of the retailers participating in the network. In addition, the system could issue, or sponsor the issuance of, credit cards or other payment mechanisms for purchases made in the network (or outside the network).

### BRIEF DESCRIPTION OF THE DRAWINGS

The objects and features of the present disclosure, which are believed to be novel, are set forth with particularity in the appended claims. The present disclosure, both as to its organization and manner of operation, together with further objectives and advantages, may be best understood by reference to the following description, taken in connection with the accompanying drawings, as set forth below:

FIG. 1 is a block diagram of an embodiment of the invention, illustrating an exemplary storage and processing structure, in accordance with the principles of the present disclosure;

FIG. 2 is a flowchart of an embodiment of the invention, illustrating the steps of an exemplary transaction, in accordance with the principles of the present disclosure;

FIG. 3 is a diagram of an embodiment of the invention, illustrating certain interactions between members and vendors, in accordance with the principles of the present disclosure;

FIG. 4 is a diagram of an embodiment of the invention, exemplifying flows of funds from the members to the central system and from the central system to the vendors, in accordance with the principles of the present disclosure;

FIG. 5 is a diagram of an embodiment of the invention, exemplifying flows of funds from the vendors to the central system and from the central system to the members, in accordance with the principles of the present disclosure.

### DETAILED DESCRIPTION OF THE EXEMPLARY EMBODIMENTS

A system that provides participating consumers with cash-back rewards on their purchases of goods and/or services from participating retailers and other sellers. The sponsor or operator of the system is referred to herein as the “central system”. A retailer or other seller that participates in the system is referred to herein as a “vendor”. A consumer that participates in the system is referred to herein as a “member”. The members and vendors that, in the aggregate, participate in the system are herein referred to as the “network”. Cash-back rewards on members' purchases from vendors are herein referred to as “cash rewards”.

In a preferred embodiment, cash rewards relating to purchases within a given membership year (or other period) are paid at or after the end of such year (or period). Members could receive, either in place of or in addition to cash rewards, price discounts on purchases from vendors and/or other benefits such as coupons or rebates. Discounts, coupons, rebates, and other benefits awarded members other than a cash reward from the central system are referred to herein as “promotional benefits”. In a preferred embodiment, any such promotional benefits are given at the point of purchase. Promotional benefits and cash rewards collectively are referred to herein as “member benefits”. As used herein, the term “payment” (and each word form thereof) refers to a payment in any form, whether made by cash, check, electronic transfer, the application of a credit or offset, or by any other means of transferring value.

In a preferred embodiment, the cash rewards apply to all goods and services available from vendors. These cash rewards could be supplemented by promotional benefits with respect to the purchase of some or all goods, services, or brands. Any such promotional benefits could vary and might apply for only limited times. They could be used, for example, as an incentive to drive the sale of certain items. Promotional benefits may be furnished by or on behalf of vendors and/or third parties (such as manufacturers and distributors).

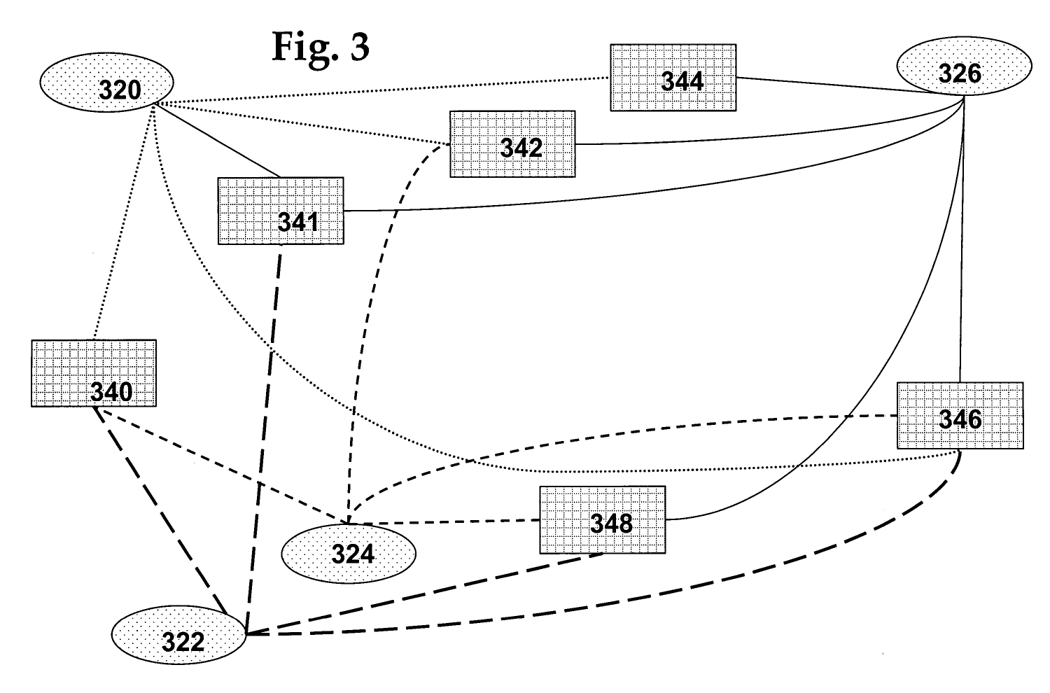

In a preferred embodiment, no retail segment within a particular geographical region is represented by more than one vendor. A single vendor can participate in one or more geographical regions. Similarly, a single vendor may participate in one or more retail segments within a geographical region. In a preferred embodiment, each vendor becomes part of the network by agreeing to comply with the central system's rules and provisions, entitling the vendor to participate in the network for the term of the agreement. Referring to FIG. 3, members 320-326 may shop at any one or more of the vendors 340-346. Likewise, vendors 340-346 may be patronized by any or all of the members 320-326.

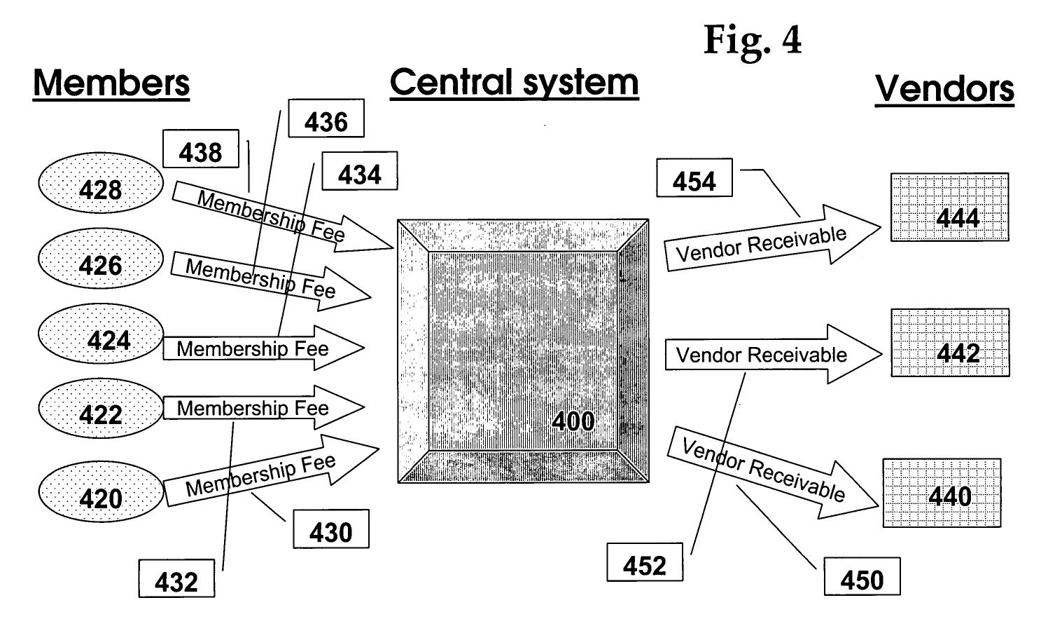

In a preferred embodiment, each member pays the central system a fee entitling him, her, or it to be a member of the network for a certain time period. A fee paid to the central system in exchange for the right to member benefits is referred to herein as a “membership fee”. Referring to FIG. 4, the members 420-428 pay their respective membership fees 430-438 to the central system 400. In a preferred embodiment, members pay an up-front annual membership fee to be a member of the network for the succeeding year. Such fee entitles the member to member benefits with respect to purchases made from vendors during such year beginning on the membership initiation or renewal date. In a preferred embodiment, membership fees are determined according to a specified schedule or formula that ties the level of member benefits (and/or limitations thereon) to the amount of the membership fee. Alternatively, a single membership fee could apply to all members.

The members may be categorized into two or more separate categories. Each category of members is herein referred to as a “membership class”. The amount of membership fees applicable to the membership classes may vary depending on the level of member benefits (and/or limitations thereon) applicable to each membership class. For example, and by way of illustration only, an annual membership fee of $50 might entitle the member to a 2% cash reward on all purchases from vendors, a $100 annual fee might entitle the member to 4% cash rewards, a $150 annual fee might entitle the member to a 6% cash reward, and a $200 membership might provide an 8% cash reward on purchases from vendors. In addition, certain member benefits could be awarded to members who do not pay any membership fee.

The aggregate amount of cash rewards and/or certain promotional benefits awarded to a member could be limited to a maximum level or amount for any membership year or other time period. Any such maximum level or amount is herein referred to as a “cap”. In a preferred embodiment, a cap would apply on an annual basis (e.g., no more than $1,000 cash back with respect to any membership year). Any such cap could apply either on an aggregate basis (i.e., an overall cap on the amount of cash rewards and/or promotional benefits earned on purchases made from all vendors participating in the network) or on a separate basis (i.e., a separate cap on the amount of cash rewards and/or promotional benefits earned on the purchases made from each particular vendor). When there are two or more membership classes, a single cap could apply to all membership classes, or separate caps could apply to the different membership classes. The structure of the membership fee and the applicable member benefits (and limitations) could depend on an assessment of various factors, including expected sales volumes, gross margins, and anticipated incremental sales arising from participation in the system.

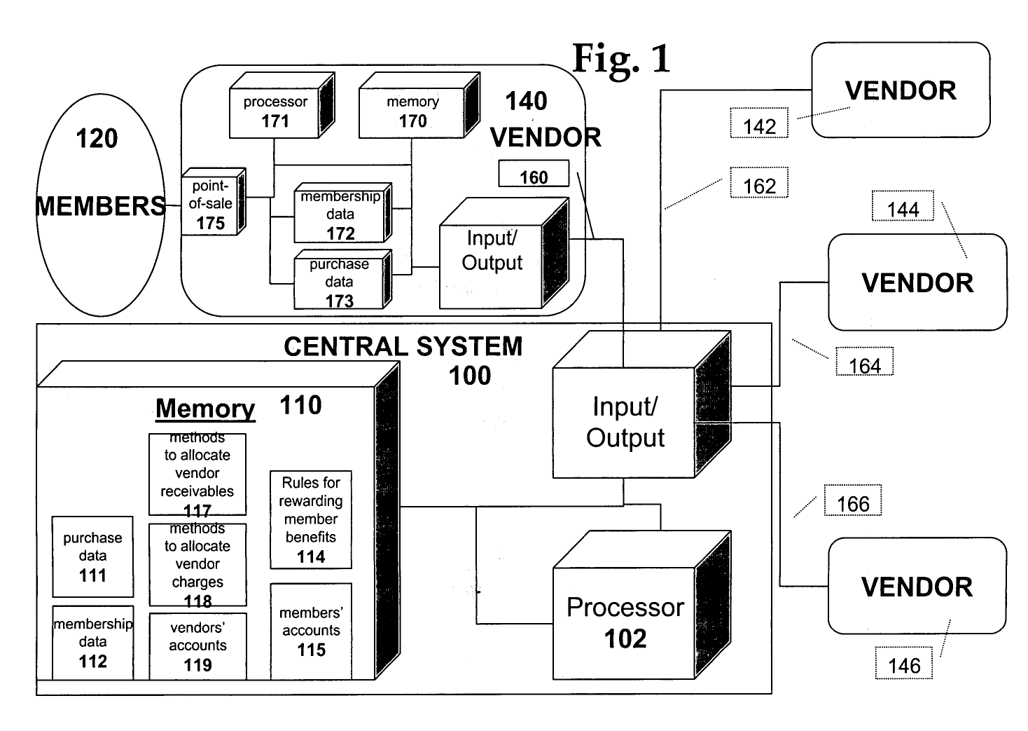

Referring now to FIG. 1, the central system 100 stores 110 the rules applicable to determine member benefits 114, and processes 102 said rules together with the purchase data 111 and membership data 112 in order to credit the member benefits applicable to each of the members 115.

The central system pays the vendors all or a portion of the membership fees. The vendors' share of the membership fees is referred to herein as the “vendor receivables”. Referring to FIG. 4, the central system 400 makes payments 450-454 to the vendors 440-444 of their respective shares of the membership fees 430-438 collected from the members 420-428. In a preferred embodiment, in the event a consumer is a member for only a portion of a year, the partial-year fee paid by that member for that year would be allocated to each month during that year in proportion to the number of his or her membership days within such months. In a preferred embodiment, all vendor receivables relating to membership fees collected in any given month (or other period) are paid to the vendors at or after the end of said month (or other period). As an alternative, the vendor receivables relating to membership fees collected in any given month may be paid to the vendors over the ensuing twelve-month period or at such other time or times as the parties may agree. Payment of the vendor receivables could be made, in whole or in part, by way of offset against the vendor charges (described below).

In a preferred embodiment, payments of the vendor receivables measured or computed by reference to the membership fees collected in any month (or other period) are allocated among the vendors according to their respective proportionate shares of the network-wide sales made for such month (or other period). The allocation of the amount of the vendor receivables among vendors may or may not take into account the applicable caps.

Alternatively, the amount of vendor receivables may be allocated among, and paid to, the vendors based on their estimated proportionate shares of the network-wide purchases by members for the ensuing year (or other period). As another alternative, such allocations may be made based on the vendors' proportionate shares of network-wide purchases by members over the past year (or other period). In either case, to the extent the estimated or historic shares, as the case may be, differ from the vendors' ultimate actual proportionate shares of network-wide purchases, adjustments periodically may be made in order to true-up the amounts due.

Referring now to FIG. 1, the central system 100 stores 110 the methods of allocating vendor receivables 117, and processes 102 said methods together with the purchase data 111 and membership data 112 in order to credit the vendor receivables to each of the vendors 119.

Still referring to FIG. 1, in a preferred embodiment, each vendor 140-146 is in electronic communication 160-166 with the central system 100. Such communications may be periodic or continuous. In a preferred embodiment, the central system 100 electronically communicates 160-166 to vendors 140-146 regular or daily updates of the identity and status of members 120. The member's name, account number, membership status, member class, and other information and data relating to the member and/or its participation in the system are herein referred to as “membership data”. The vendors 140-146 could store 170 any of this membership data 172 for faster processing 171. Alternatively, the vendors 140-146 may electronically communicate 160-166 any or all of the membership data 172 to the central system 100 for verification.

In a preferred embodiment of the system, members would be issued cards containing certain membership data. Such data may be printed on the card as words, numbers, strings of letters and/or numerals, and/or pictures. Any such data may be encoded (e.g., bar code), or stored electronically (e.g., magnetic strip) in addition to or instead of being printed. A card containing membership data in any one or more such forms for use with the system is referred to herein as a “membership card”. In a preferred embodiment of the system, a member would present his or her membership card to the vendor, or would otherwise furnish the vendor with his or her relevant membership data. In the case of self-checkout, a member could scan the membership card or enter the membership data.

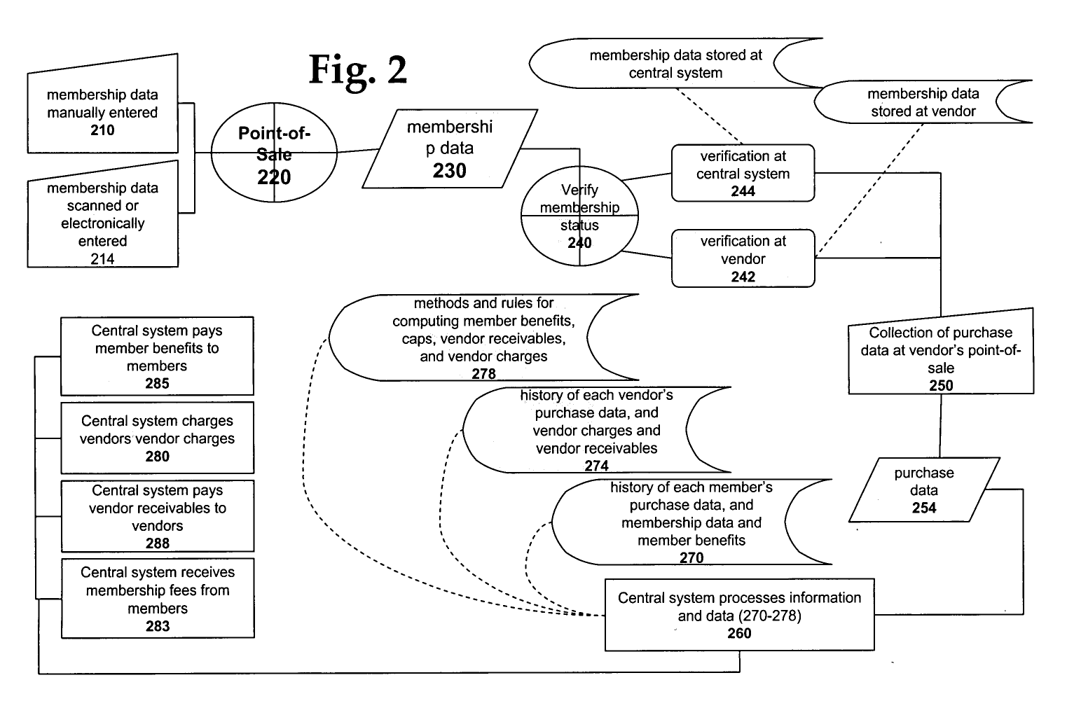

Referring now to FIG. 2, in a preferred embodiment, at the point of sale 220, the membership card would be electronically scanned 214, or the relevant membership data would be manually entered 210, in order to produce the membership data 230 that enable verification of the purchaser's membership status 240. Membership status may be verified at the vendor 242 or at the central system 244. This verification may be electronic and/or physical (i.e., visual). Visual or physical verification could be accomplished by checking the name shown on the membership card (or the name linked to the account number) against the name shown on a debit or credit card (or bank check), a driver's license, or other acceptable form of identification. For purchasers who pay with cash or other means, visual identity verification, if desired, can be accomplished by having the membership card display (or store electronically) a picture of the member. A vendor that has in place other security or identification methods or devices (e.g., fingerprint identification, eyeball identification, etc.) can integrate such methods and/or devices with the system, or such implementation could be incorporated into the membership card.

A vendor collects 250 the information and data 254 relating to the purchase made by the member. In a preferred embodiment, such information and data include the name and account number of the member, the member's membership class (if applicable), the amount of the purchase, the date of the purchase, and the name and/or network identification number of the vendor. Such information and data relating to a member's purchase from a vendor are herein referred to as “purchase data”. Referring now to FIG. 1, in a preferred embodiment, the vendor 140 electronically enters and records at the point of sale 175 the purchase data 173 relating to purchases made by members 120.

Still referring to FIG. 1, the vendor 140 communicates 160 the purchase data 173 to the central system 100. In a preferred embodiment, the vendor 140, at the point of sale 175, electronically communicates 160 the relevant purchase data 173 to the central system 100. In a preferred embodiment, the central system 100 would electronically process 102 and store 110 all membership data 112 and purchase data 1111. In a preferred embodiment of the system, a vendor 140 employs its existing point-of-sale terminals 175 as means for scanning and/or entering membership data 172 and purchase data 173, and as means for communicating 162 with the central system 100.

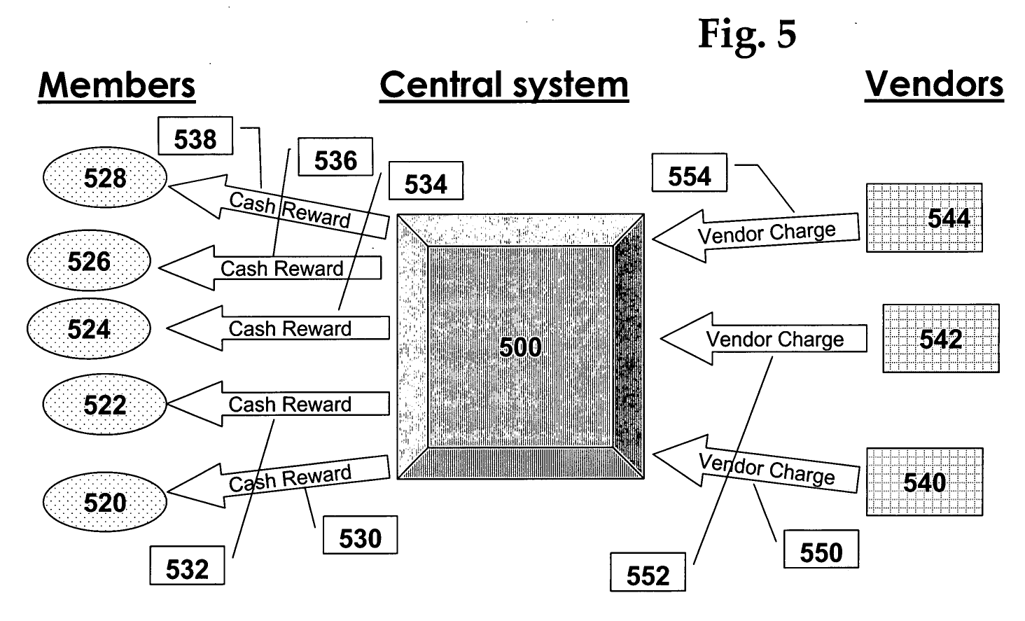

The central system charges each vendor the amount of such vendor's share of the cash rewards due members. A vendor's share of the cash rewards due members in any month (or other period) is referred to herein as a “vendor charge”. Referring to FIG. 5. in a preferred embodiment of the system, vendors 540-544 pay their respective vendor charges 560-564 to the central system 500 at or after the end of each month (or other period), but in advance of the central system's paying the members the cash rewards relating thereto. In a preferred embodiment, the central system 500 uses its receipts from vendor charges 550-554 as a source for paying cash rewards 530-538 to the members 520-528. Payments of cash rewards may be made in any form agreed to by the parties, including by check, electronic transfer, or credit against membership fees, or any combination thereof.

Referring now to FIG. 1, the central system 100 stores 110 the methods for determining vendor charges 118, and processes 102 said methods together with the purchase data 111 and membership data 112 in order to allocate the vendor charges to each of the vendors 119.

Referring now to FIG. 2, the central system stores the history of each member's purchase data and member benefits 270, the history of the vendor charges and vendor receivable allocated to each vendor 274, and the methods and rules for computing member benefits, caps, vendor receivables, and vendor charges 278. The central system processes this stored data and information 260, receives vendor charges from vendors 280 and membership fees from members 283, and makes payments of member benefits to members 285 and vendor receivables to vendors 288.

A membership card and/or member account number may be used to confer on a member the benefits with respect to purchases from a particular vendor that would be provided by a loyalty card issued by or for such vendor. A single membership card could be used to integrate any or all of the member's loyalty cards (or similar programs) with the various participating vendors and non-network sellers.

The membership card could be issued in conjunction with a credit card, debit card, checking card, or other means for making payment. A credit card, debit card, checking card, or other means for making payment is herein referred to as a “payment mechanism”. A single membership card could be used in conjunction with any single payment mechanism or any combination or aggregate of payment mechanisms.

What is claimed is:

1. A method of providing cash rewards to members who make purchases from vendors, comprising:
(a) at the point of sale by said vendor to said member, obtaining certain membership data relating to said member;
(b) at said point of sale, collecting certain purchase data with respect to the sale by said vendor to said member;
(c) means for communicating certain membership data from said vendors to the central system;
(d) means for communicating certain purchase data from said vendors to said central system;
(e) means for computing the amount of members' cash rewards with respect to said sales by said vendors;
(f) means for computing the amount of vendor charges with respect to said cash rewards allocable to said vendors;
(g) means for determining the amount of the membership fees; and
(h) means for computing the amount of the vendor receivables with respect to said membership fees allocable to said vendors.

2. The method of claim 1, wherein the computation and credit to the members of the cash rewards with respect to said members' respective purchases from the vendors is based on a single system-wide rate of such purchases.

3. The method of claim 1, wherein the computation and credit to the members of the cash rewards with respect to said members' respective purchases from the vendors is based on a rate of such purchases that varies among the members.

4. The method of claim 1, wherein the computation and credit to the members of the cash rewards with respect to said members' respective purchases from the vendors is based on a rate of such purchases that varies among the vendors.

5. The method of claim 1, wherein the membership fees are based on a single system-wide rate.

6. The method of claim 1, wherein the membership fees vary in amount among certain members.

7. The method of claim 1, wherein there is a single membership class.

8. The method of claim 1, wherein there is a plurality of membership classes.

9. The method of claim 6 wherein said variance in membership fees corresponds to the varying membership classes.

10. The method of claim 6, wherein said variance in membership fees corresponds to the varying reward levels of said members.

11. The method of claim 1, further comprising certain vendors' granting members discounts on certain purchases made by said members.

12. The method of claim 1, further comprising certain vendors' awarding members certain promotional benefits.

13. The method of claim 12, wherein the central system awards said promotional benefits to the members.

14. The method of claim 12, wherein a third party awards said promotional benefits to the members.

15. The method of claim 1, further comprising the issuance to certain members of membership cards containing certain membership data associated with each said member.

16. The method of claim 1, further comprising the association of certain of said membership data with at least one payment mechanism.

17. The method of claim 1, further comprising the association of certain of said membership data with at least one item of other data.

18. The method of claim 15, wherein said membership cards also function as payment mechanisms.

19. The method of claim 1, further comprising the association of certain membership data of certain members with their respective participation in certain vendors' loyalty card programs.

20. The method of claim 1, further comprising the association of certain membership data of certain members with their respective participation in loyalty card programs of certain non-network sellers.

21. The method of claim 15, wherein said membership cards also function as loyalty cards of certain vendors.

22. The method of claim 15, wherein said membership cards also function as loyalty cards of non-network sellers.

23. A method of providing cash rewards to members who make purchases from vendors, comprising:
(a) means for computing the amount of members' cash rewards with respect to said sales by said vendors; and
(b) means for computing the amount of vendor charges with respect to said cash rewards allocable to said vendors.

24. A method of providing cash rewards to members who make purchases from vendors, comprising:
(a) means for determining the amount of the membership fees; and
(b) means for computing the amount of the vendor receivables with respect to said membership fees allocable to said vendors.
